(19) United States
(12) Patent Application Publication
(10) Pub. No.: US 2020/0358705 A1
(43) Pub. Date: Nov. 12, 2020

(54) PRIORITY-BASED DATA TRANSMISSION METHOD AND SYSTEM THEREOF

(71) Applicant: GETAC TECHNOLOGY CORPORATION, HSINCHU COUNTY (TW)

(72) Inventor: SHI-TSAN LIN, Taipei City (TW)

(21) Appl. No.: 16/405,943

(22) Filed: May 7, 2019

(51) Int. Cl. H04L 12/851

(52) U.S. Cl. CPC H04L 47/2433

(57) ABSTRACT

A priority-based data transmission method and a system thereof are provided. The priority-based data transmission method performs attribute classification on multiple sets of data stored in an electronic device to obtain multiple corresponding weight values, and calculates the multiple weight values to obtain a priority value. The electronic device broadcasts a priority value thereof at a fixed time, and at the same time receives priority values broadcasted by other electronic devices. Each electronic device establishes a priority sequence according to all of the priority values, and transmits data according to the priority sequence, thereby effectively avoid network congestion and alleviating the load of a server.

### BACKGROUND OF THE INVENTION

### Field of the Invention

The present invention relates to a data transmission method and a system thereof, and more particularly to priority-based data transmission method, in which an electronic device establishes a priority sequence by calculating a priority value thereof and on the basis of multiple priority values of other electronic devices, and a system thereof.

### Description of the Prior Art

In general, when multiple devices are to concurrently upload data to a server, and more particularly when there are a large number of devices or a large amount of data, a situation of the devices competing against one another is caused, resulting in a drastically increased probability of network congestion, while also increasing the loading of the server. Further, a user can configure a resource manager by means of an intermediate device such as a hub, a switch or a router to designate permission tags, and a device having a permission tag signifies the entitlement to the priority for uploading data. The resource manager defines an access schedule according to application sequences of devices, and avoids the occurrence of the devices competing against one another according to a priority sequence.

Although the loading of a server can be alleviated by means of the resource manager, the loading of the resource manager is however significantly increased due to the increased number of devices. In more severe cases, an intermediate device having the resource manager may crash and cause data uploading failures of some devices or all devices. Therefore, it is an object of the present invention to provide, in an environment where multiple devices need to upload data, a solution for avoiding overloading of a server as well as preventing an intermediate device having a resource manager from crashing, while ensuring that data to be transmitted by each of the devices can be successfully uploaded to the server.

### SUMMARY OF THE INVENTION

In view of the above, a priority-based data transmission method is provided according to an embodiment of the present invention. The method, applicable to an electronic device, includes: the electronic device performing attribute classification on multiple sets of data stored therein to obtain multiple data attributes, and setting multiple weight values respectively corresponding to the multiple data attributes; the electronic device performing calculation according to the multiple weight values to obtain a priority value; and the electronic device broadcasting the priority value at a fixed time, receiving and recording priority values broadcasted by other electronic devices, and establishing a priority sequence according to the multiple priority values of the electronic device and the other electronic devices.

A priority-based data transmission system is further provided according to another embodiment of the present invention. The system includes a remote device and multiple electronic devices electrically connected to the remote device. Each of the electronic devices includes a storage device for storing a program, and the program is for instructing each of the electronic devices to perform a priority-based data transmission method. The method includes: each of the electronic devices performing attribute classification on multiple sets of data stored therein to obtain multiple data attributes, and setting multiple weight values respectively corresponding to the multiple data attributes; each of the electronic devices performing calculation according to the multiple weight values to obtain a priority value; each of the electronic devices broadcasting the priority value at a fixed time, receiving and recording priority values broadcasted by the other electronic devices, and establishing a priority sequence according to all of the multiple priority values; and determining that N among the multiple electronic devices have an access right priority for transmitting data to the remote device according to the priority sequence, wherein N is a positive integer greater than or equal to 1.

In the priority-based data transmission method and the system thereof provided according to the embodiments of the present invention, each electronic device performs attribute classification on multiple sets of data stored therein to obtain multiple corresponding weight values, and performs calculation according to the multiple weight values to obtain a priority value. Each electronic device then broadcasts the priority value thereof at a fixed time, and at the same time receives the priority values broadcasted by other electronic devices. Next, each electronic device establishes a priority sequence according to the priority values, and transmits data to the remote device according to the priority sequence. Thus, network congestion is effectively avoided, the loading of a server is alleviated, and meanwhile an intermediate device is prevented from crashing.

To better understand the above and other objects, features and advantages of the present invention, embodiments are described in detail with the accompanying drawings in the description below.

### BRIEF DESCRIPTION OF THE DRAWINGS

FIG. 1 depicts a flowchart of a priority-based data transmission method according to an embodiment of the present invention;

FIG. 2 depicts a block diagram of an electronic device according to an embodiment of the present invention;

FIG. 3 depicts a block diagram of a priority-based data transmission system according to an embodiment of the present invention;

FIG. 4 depicts a block diagram of a priority-based data transmission system according to another embodiment of the present invention; and

FIG. 5 depicts a flowchart of a priority-based data transmission method according to another embodiment of the present invention.

### DETAILED DESCRIPTION OF THE EMBODIMENTS

A priority-based data transmission method and a system thereof provided according to embodiments of the present invention are applicable to a device transmitting audio/video data or other data by means of the Internet or Internet of Things (IoT), wherein the device can be, for example, a body camera. In the embodiments of the present invention, an instruction of a program for performing a priority-based data transmission method is stored in a storage device, and the instruction of the program is executed by a processor electrically connected to the storage device to control operations of the electronic device.

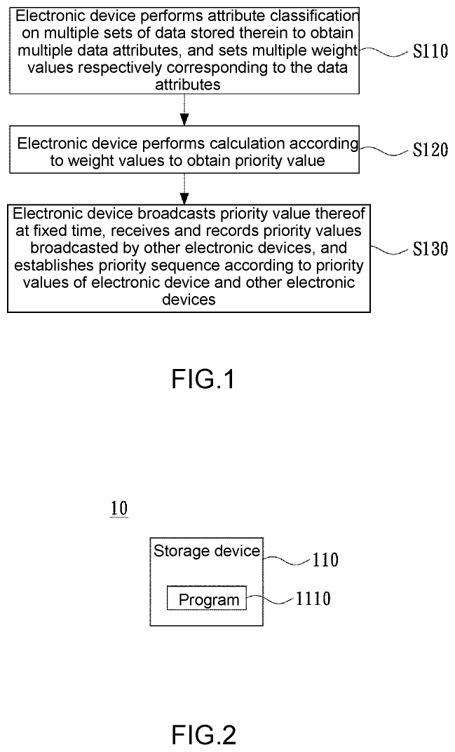

Refer to both FIG. 1 and FIG. 2. FIG. 1 shows a flowchart of a priority-based data transmission method according to an embodiment of the present invention. FIG. 2 shows a block diagram of an electronic device according to an embodiment of the present invention.

In this embodiment, a priority-based data transmission method is applicable to an electronic device 10. As shown in FIG. 2, the electronic device 10 includes a storage device 110 storing a program 1110, wherein the program 1110 is for instructing the electronic device 10 to perform the priority-based data transmission method. The storage device 110 can be, for example, a storage medium such as a random access memory (RAM), a computer memory including a RAM and a read-only memory (ROM) or a memory card, for storing the instruction for performing the priority-based data transmission method. Further, the instruction of the program 1110 is executed by a processor (not shown) electrically connected to the storage device 110 to control the electronic device 10 to perform multiple operations.

As shown in FIG. 1, the above priority-based data transmission method can include the following steps. In step S110, the electronic device 10 performs attribute classification on multiple sets of data according to the multiple sets of data stored to obtain multiple data attributes, and sets multiple weight values respectively corresponding to the multiple data attributes. The electronic device 10 can be, for example, a device having a video recording function such as a handheld camera or a body camera, or a device having an audio recording function. For instance, image data recorded by a body camera worn by a police officer on-duty is taken as an example. The data attributes can be one or multiple different events included in the image data, and the events can be preset with different weight values. For example, the weight value can be preset as 1 for a system test event, 3 for a patrol event, 5 for a traffic event, 10 for a family dispute event, 15 for a drink-and-drive event, 15 for a dangerous driving event, and 20 for a severe social event. It should be noted that, the events included in the above image data, such as a system test event, a patrol event, a traffic event, a family dispute event, a drink-and-drive event, a dangerous driving event and a severe social event can be an event classified as a particular event manually after the police officer has recorded the image data, or can be automatically classified as a particular event according to an image analysis result provided by built-in image analysis software of the electronic device 10.

In step S120, the electronic device 10 performs calculation according to the multiple weight values to obtain a priority value. In general, the priority in a priority sequence gets higher as the priority value gets larger. Assuming that the image data of the electronic device 10 is primarily related to a severe social event, the priority value obtained is larger and thus has a higher priority located closer to the beginning of a priority sequence, so as to transmit important data in real time. Conversely, if the image data of the electronic device 10 is primarily related to patrol, the priority value obtained is smaller and thus has a lower priority located closer to the end of a priority sequence, so as to transmit less important data.

In step S130, the electronic device 10 broadcasts the priority value at a fixed time, receives and records the priority values broadcasted by other electronic devices 10, and establishes a priority sequence according to the multiple priority values of the electronic device 10 and the other electronic devices 10. In general, a police officer needs to upload image data recorded on-duty to a server before getting off work. To prevent network congestion caused by rush hours, the electronic device 10 and other electronic devices within the same local area network broadcast respective priority values thereof at fixed times, wherein the fixed times can be configured according to conditions of a software and hardware environment of a network system at that time. For example, in a network system having a higher data transmission rate, it can be configured to perform broadcasting once at an interval of, e.g., every 30 seconds; in contrast, in a network system having a lower data transmission rate, it can be configured to perform broadcasting once at an interval of, e.g., every one minute or every two minutes. The electronic device 10 establishes a priority sequence according to the priority value thereof and multiple priority values broadcasted by other electronic devices.

It should be noted that, because the electronic device 10 and the other electronic devices broadcast respective priority values at fixed times, each of the electronic devices can establish a priority sequence according to the priority value thereof as well as the priority values it receives and broadcasted by the other electronic devices. In other words, there is only one priority sequence, and all of the electronic devices need to queue in order to transmit data thereof according to this priority sequence. Since all priority sequences are individually provided at respective device ends or local ends, a resource manager of an intermediate device for establishing a priority sequence is not required, thereby preventing the intermediate device from crashing due to overloading, and at the same time effectively avoiding overloading of a server. The above intermediate device is, for example, a hub, a switch or a router.

In step S120 in which the electronic device 10 performs calculation according to the multiple weight values to obtain the priority value, the priority value can be calculated according to an equation: PV=C*Σᵢ₌₁^{k} VIWi, where PV represents the priority value of the electronic device 10, C is a positive integer greater than or equal to 1, Σᵢ₌₁^{k} VIWi represents a sum of multiple weight values corresponding to multiple data attributes of multiple sets of data, i represents one set of the multiple sets of data, and k is a positive integer greater than or equal to 1. The value C can be set according to the number of electronic devices. For example, if there are 512 electronic devices to concurrently upload data, C can be set as 512. For example, assuming a condition of C being 512, if the image data stored by the electronic device 10 includes five patrol events, three traffic events, and one family dispute event, the priority value of the electronic device 10 at this point is 20480. Further, if the image data stored in the electronic device 10 includes one severe social event, one dangerous driving event and one traffic event, the priority value of the electronic device 10 at this point is 20480. Further, if the image data stored in the electronic device 10 includes five patrol events, two traffic events, and one drink-and-drive event, the priority value of the electronic device 10 at this point is 20480. It is seen that, it is possible that the same priority value can be obtained even though the image data stored in the electronic device 10 is different.

Therefore, to reduce the occurrence of the same priority value, in this embodiment, the electronic device 10 can perform calculation according to the multiple weight values added by a random number to obtain the priority value. Thus, the priority value can be calculated according to an equation: PV=C*Σᵢ₌₁^{k} VIWi+RND, where PV represents the priority value of the electronic device 10, C is a positive integer greater than or equal to 1, Σᵢ₌₁^{k} VIWi represents a sum of multiple weight values corresponding to multiple data attributes of multiple sets of data, i represents one set of the multiple sets of data, k is a positive integer greater than or equal to 1, and RND represents a random number of the electronic device 10. For example, assuming that C is 512 and RND is a random number between 0 and 512, if the image data stored by the electronic device 10 includes five patrol events, three traffic events, and one family dispute event, the priority value of the electronic device 10 at this point is 20906. Further, if the image data stored in the electronic device 10 includes one severe social event, one dangerous driving event and one traffic event, the priority value of the electronic device 10 at this point is 20562. Further, if the image data stored in the electronic device 10 includes five patrol events, two traffic events, and one drink-and-drive event, the priority value of the electronic device 10 at this point is 20893. It is seen that, by adding the random number into the calculation, the priority values obtained are no longer the same, thereby eliminating the occurrence of the same priority value.

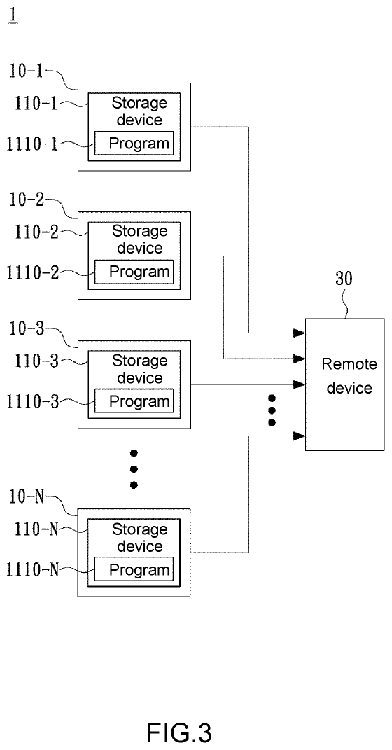

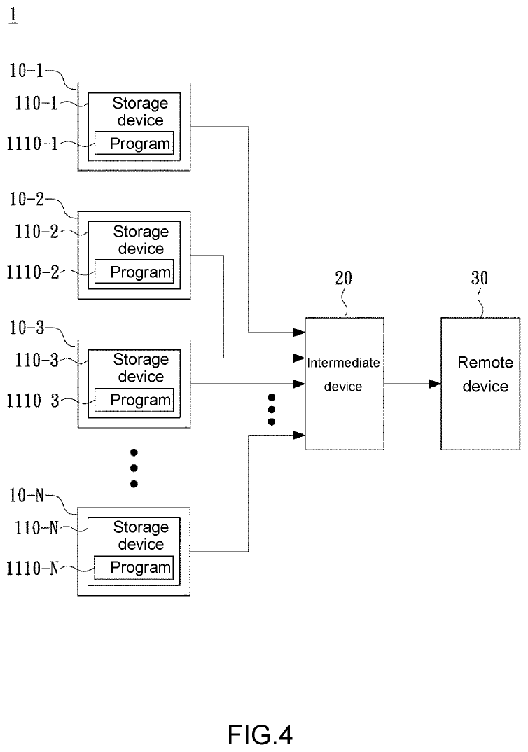

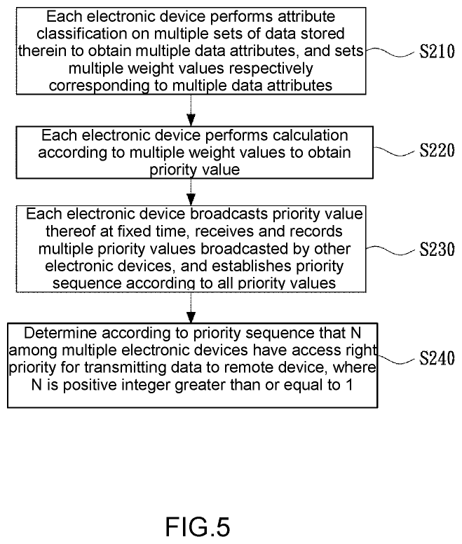

In the description below, it is illustrated how the priority-based transmission method provided according to the embodiment of the present invention can be performed in a priority-based data transmission system 1. Refer to FIG. 3 to FIG. 5. FIG. 3 shows a block diagram of a priority-based data transmission system according to an embodiment of the present invention. FIG. 4 shows a block diagram of a priority-based data transmission system according to another embodiment of the present invention. FIG. 5 shows a flowchart of a priority-based data transmission method according to another embodiment of the present invention. However, the present invention does not limit that the priority-based data transmission method in FIG. 1 is performed in only the priority-based data transmission system 1 in FIG. 3 or FIG. 4.

As shown in FIG. 3, in this embodiment, the priority-based data transmission system 1 includes a remote device 30, and multiple electronic devices 10-1 to 10-N electrically connected to the remote device 30. The remote device 30 is, for example, a server or a network-attached storage device. It should be noted that, the communication between the remote device 30 and the multiple electronic devices 10-1 to 10-N can be a wireless communication means such as Wi-Fi or 4G, or can be a wired communication means such as ADSL or optical fiber, for transmitting and communicating signals.

Further, as shown in FIG. 4, the priority-based data transmission system 1 of this embodiment can further include an intermediate device 20, one end of which is electrically connected to the remote device 30 and the other end is electrically connected to the multiple electronic devices 10-1 to 10-N. The intermediate device 20 is, for example, a network device such as a hub, a switch or a router. It should be noted that, the communication between the remote device 30 and the intermediate device 20, and the communication between the intermediate device 20 and the multiple electronic devices 10-1 to 10-N can be wireless communication means such as Wi-Fi or 4G, or can be wired communication means such as ADSL or optical fiber, for transmitting and communicating signals.

The electronic devices 10-1 to 10-N respectively include storage devices 110-1 to 110-N respectively storing programs 1110-1 to 1110-N, wherein the programs 1110-1 to 1110-N are for the respective electronic devices 10-1 to 10-N to perform a priority-based data transmission method. Each of the storage devices 110-1 to 110-N can be, for examples, a storage medium such as a random access memory (RAM), a computer memory including a RAM and a read-only memory (ROM) or a memory card, for storing the instruction for performing the priority-based data transmission method. Further, the instructions of the programs 1110-1 to 1110-N are executed by a processor (not shown) electrically connected to the storage devices 110-1 to 110-N to control multiple operations between the electronic devices 10-1 to 10-N and the remote device 30. It should be noted that, some of the steps of the process of the priority-based data transmission method are described in detail in the foregoing embodiment, and only associated description is given in brief rather repeating the same details.

As shown in FIG. 5, the priority-based data transmission method can include the following steps. In step S210, each of the electronic devices 10-1 to 10-N performs attribute classification on multiple sets of data according to the multiple sets of data stored to obtain multiple data attributes, and sets multiple weight values respectively corresponding to the multiple data attributes. In step S220, each of the electronic devices 10-1 to 10-N performs calculation according to the multiple weighting values to obtain a priority value. For example, the priority value can be calculated according to an equation: PV=C*Σᵢ₌₁^{k} VIWi, where PV represents the priority value of one of the electronic devices 10-1 to 10-N, C is a positive integer greater than or equal to 1, Σᵢ₌₁^{k} VIWi represents a sum of multiple weight values corresponding to multiple data attributes of one set of multiple sets of data, i represents one set of the multiple sets of data, and k is a positive integer greater than or equal to 1. Alternatively, each of the electronic devices 10-1 to 10-N can perform calculation according to the multiple weight values added by a random number to obtain the priority value. For example, the priority value can be calculated according to an equation: PV=C*Σᵢ₌₁^{k} VIWi+RND, where PV represents the priority value of one of the electronic devices 10-1 to 10-N, C is a positive integer greater than or equal to 1, Σᵢ₌₁^{k} VIWi represents a sum of multiple weight values corresponding to multiple data attributes of one set of multiple sets of data, i represents one set of the multiple sets of data, k is a positive integer greater than or equal to 1, and RND represents a random number of one of the electronic devices 10-1 to 10-N.

In step S230, each of the electronic devices 10-1 to 10-N broadcasts the priority value thereof at a fixed time, receives and records the multiple priority values broadcasted by the other electronic devices, and establishes a priority sequence according to all of the priority values. Assuming that the fixed time is one minute, then each of the electronic devices 10-1 to 10-N broadcasts the priority value thereof at an interval of every one minute. It is also assumed that the electronic devices 10-1 to 10-N broadcast at almost the same time. As shown in Table 1, before the electronic device 10-1 connects to a network and begins to upload data, the electronic device 10-1 broadcasts the priority value thereof obtained according to the above priority-based data transmission method, at the same time receives and records (N−1) priority values broadcasted by other electronic devices (i.e., the electronic devices 10-2 to 10-N), and establishes a priority sequence according to the N priority values. Similarly, before the electronic device 10-N connects to a network and begins to upload data, the electronic device 10-N broadcasts the priority value thereof obtained according to the priority-based data transmission method, at the same time receives and records the N−1 priority values of the other electronic devices (i.e., the electronic devices 10-1 to 10-(N−1)), and establishes a priority sequence according to the N priority values. In general, the priority in a priority sequence gets higher as the priority value increases. As shown in Table 2, the electronic device 10-N has the largest priority value and thus has a first priority in the priority sequence. Similarly, the electronic device 10-1 has the smallest priority value and thus has a last priority in the priority sequence.

It should be noted that, if one (e.g., the electronic device 10-1) among the electronic devices 10-1 to 10-N does not broadcast the priority value thereof at a fixed time, the electronic device 10-1 is removed from the priority sequence. Further, if one (e.g., the electronic device 10-N) among the electronic devices 10-1 to 10-N has completed data uploading, the electronic device 10-N no longer broadcasts the priority value thereof, i.e., the electronic device 10-N is also removed from the priority sequence. Further, if one (e.g., the electronic device 10-2) among the electronic devices 10-1 to 10-N is disconnected and reconnected to a network, or again joins a network, the electronic device 10-2 needs to again calculate the priority value thereof and broadcast the priority value thereof at a fixed time.

TABLE 1

| Name of device | Priority value | Time |
|---|---|---|
| Electronic device 10-1 | 7756 | 00:10 |
| Electronic device 10-2 | 25676 | 00:10 |
| Electronic device 10-3 | 12876 | 00:10 |
| Electronic device 10-4 | 38536 | 00:10 |
| . | . | . |
| . | . | . |
| . | . | . |
| Electronic device 10-N | 51398 | 00:10 |

TABLE 2

| Name of device | Priority in priority sequence |
|---|---|
| Electronic device 10-N | 1 |
| Electronic device 10-4 | 2 |
| Electronic device 10-2 | 3 |
| Electronic device 10-3 | 4 |
| . | . |
| . | . |
| . | . |
| Electronic device 10-1 | N |

In step S240, according to the priority sequence, it is determined that N among the multiple electronic devices 10-1 to 10-N have an access right priority for transmitting data to the remote device, where N is a positive integer greater than or equal to 1. The value N determined for the multiple electronic devices 10-1 to 10-N can be set according to conditions of a software and hardware environment of the network system at that time. For example, N can be set to eight in a network system having a higher data transmission rate, or set to three in a network system having a lower data transmission rate.

In conclusion, in the priority-based data transmission method and the system thereof provided according to the embodiments of the present invention, each electronic device performs attribute classification on multiple sets of data stored therein to obtain multiple corresponding weight values, and performs calculation according to the multiple weight values to obtain a priority value. Each electronic device then broadcasts the priority value thereof at a fixed time, and at the same time receives and records the priority values broadcasted by other electronic devices. Next, each electronic device establishes a priority sequence according to all of the priority values, and transmits data to the remote device according to the priority sequence thereof. Thus, network congestion is effectively avoided, the loading of a server is alleviated, and meanwhile an intermediate device is prevented from crashing due to overloading, thereby ensuring that the data to be transmitted by each electronic device can be successfully uploaded to a server and allowing an electronic device having important data stored therein to be prioritized to transmit data.

While the invention has been described by way of the embodiments, it is to be understood that the invention is not limited thereto. A person skilled in the art can make slight variations and modifications without departing from the spirit and scope of the present invention. Therefore, the claimed scope of the present invention should be accorded with the appended claims.

What is claimed is:

1. A priority-based data transmission method, applicable to an electronic device, the method comprising:
the electronic device performing attribute classification on a plurality of sets of data according to the plurality of sets of data stored therein to obtain a plurality of data attributes, and setting a plurality of weight values respectively corresponding to the plurality of data attributes;
the electronic device performing calculation according to the weight values to obtain a priority value; and
the electronic device broadcasting the priority value at a fixed time, receiving and recording priority values broadcasted by other electronic devices, and establishing a priority sequence according to the priority values of the electronic device and the other electronic devices.

2. The priority-based data transmission method according to claim 1, wherein a priority in the priority sequence gets higher as the priority value increases.

3. The priority-based data transmission method according to claim 1, wherein in the step of the electronic device calculating the weight values to obtain the priority value, the priority value is calculated according to an equation: PV=C*Σᵢ₌₁^{k} VIWi, where PV represents the priority value of the electronic device, C is a positive integer greater than or equal to 1, Σᵢ₌₁^{k} VIWi represents a sum of the weight values corresponding to the data attributes of the sets of data, i represents one set of the sets of data, and k is a positive integer greater than or equal to 1.

4. The priority-based data transmission method according to claim 1, wherein in the step of the electronic device calculating the weight values to obtain the priority value, the electronic device performs calculation according the weight values added by a random number to obtain the priority value.

5. The priority-based data transmission method according to claim 4, wherein in the step of the electronic device performing calculation according to the weight values added by the random number to obtain the priority value, the priority value is calculated according to an equation: PV=C*Σᵢ₌₁^{k} VIWi+RND, where PV represents the priority value of the electronic device, C is a positive integer greater than or equal to 1, Σᵢ₌₁^{k} VIWi represents a sum of the weight values corresponding to the data attributes of the sets of data, i represents one set of the sets of data, k is a positive integer greater than or equal to 1, and RND represents a random number of the electronic device.

6. A priority-based data transmission system, comprising:
a remote device; and
a plurality of electronic devices, electrically connected to the remote device, each of the electronic devices comprising a storage device storing a program, the program for instructing each of the electronic devices to perform a priority-based data transmission method, the method comprising:
each of the electronic devices performing attribute classification on a plurality of sets of data according to the plurality of sets of data stored therein to obtain a plurality of data attributes, and setting a plurality of weight values respectively corresponding to the plurality of data attributes;
each of the electronic devices performing calculation according to the weight values to obtain a priority value;
each of the electronic devices broadcasting the priority value at a fixed time, receiving and recording priority values broadcasted by other electronic devices, and establishing a priority sequence according to all of the priority values; and
determining according to the priority sequence that N among the electronic devices have an access right priority for transmitting data to the remote device, where N is a positive integer greater than or equal to 1.

7. The priority-based data transmission system according to claim 6, further comprising an intermediate device, wherein one end of the intermediate device is electrically connected to the remote device and one other end of the intermediate device is electrically connected to the electronic devices.

8. The priority-based data transmission system according to claim 6, wherein in the step of each of the electronic devices calculating the weight values to obtain the priority value, the priority value is calculated according to an equation: PV=C*Σᵢ₌₁^{k} VIWi, where PV represents the priority value of one of the electronic devices, C is a positive integer greater than or equal to 1, Σᵢ₌₁^{k} VIWi represents a sum of the weight values corresponding to the data attributes of one set of the sets of data, i represents one set of the sets of data, and k is a positive integer greater than or equal to 1.

9. The priority-based data transmission system according to claim 6, wherein in the step of each of the electronic devices calculating the weight values to obtain the priority value, each of the electronic devices performs calculation according to the weight values added by a random number to obtain the priority value.

10. The priority-based data transmission system according to claim 9, wherein in the step of each of the electronic devices performing calculation according to the weight values added by the random number to obtain the priority value, the priority value is calculated according to an equation: PV=C*Σᵢ₌₁^{k} VIWi+RND, where PV represents the priority value of one of the electronic device, C is a positive integer greater than or equal to 1, Σᵢ₌₁^{k} VIWi represents a sum of the weight values corresponding to the data attributes of one set of the sets of data, i represents one set of the sets of data, k is a positive integer greater than or equal to 1, and RND represents the random number of one of the electronic device.
